(19) United States
(12) Patent Application Publication
(10) Pub. No.: US 2025/0239941 A1
(43) Pub. Date: Jul. 24, 2025

(54) Zero Voltage Switching in Buck Topology

(71) Applicant: Rompower Technology Holdings, LLC, Milford, DE (US)

(72) Inventor: Ionel Jitaru, Tucson, AZ (US)

(73) Assignee: Rompower Technology Holdings, LLC, Milford, DE (US)

(21) Appl. No.: 19/036,996

(22) Filed: Jan. 24, 2025

Related U.S. Application Data
(60) Provisional application No. 63/624,654, filed on Jan. 24, 2024.

(51) Int. Cl. H02M 3/158; H02M 1/00; H02M 1/32

(52) U.S. Cl. CPC H02M 3/158; H02M 1/0058; H02M 1/32

(57) ABSTRACT

A buck topology operates in discontinuous mode in which energy contained in the parasitic oscillations is harvested as needed, with additional energy provided by a voltage injection source, the power switchers of the buck topology turn on at zero voltage in any operating conditions.

### CROSS-REFERENCE TO RELATED APPLICATIONS

This application claims the benefit of U.S. Provisional Application No. 63/624,654, filed Jan. 24, 2024, which is hereby incorporated by reference in its entirety.

### FIELD

The present specification relates generally to power conversion, and more particularly to zero voltage switching in buck topology.

### BACKGROUND

The world of technology has witnessed unprecedented growth in recent years, with Artificial Intelligence (AI) taking the lead in driving innovation and transforming industries. As AI becomes more embedded in our everyday lives, the demand for specialized hardware to support these complex applications is rising. One such component is the Artificial Intelligence processor, designed to enable faster and more efficient AI processing.

A normal processor, such as a CPU, is designed to handle various tasks and calculations. It can execute multiple instructions simultaneously, making it suitable for everyday computing tasks like browsing the internet, word processing, and video playback.

On the other hand, an AI processor, also known as an Artificial Intelligence Processor or AI Processor Chip, is specifically designed to handle the complex computations and data processing required for AI workloads. These processors are optimized for tasks like machine learning, natural language processing, and computer vision, which demand high levels of parallel processing and substantial memory bandwidth.

Traditional point of load (POL) converters are using buck power trains and interleaved buck power trains. The increase in power levels for AI Processor chips which go towards 750 W and 1 KW for 1V output has created many challenges. The 12V bus is presently replaced by 48V bus. Losses in conventional buck topologies can be traced to several specific sources, such as hard switching, body diode conduction and gate driving loss. The operation frequency of the buck power cells is at hundreds of Khz, between 500 Khz towards 1 Mhz, and zero voltage switching feature becomes an imperative especially for application wherein 12V bus was replaced by a 48V buss.

### SUMMARY

A buck converter includes an input voltage source having first and second terminals, an inductive element, and an output capacitor connected in parallel to a load resistor. A first power switch has first and second terminals and a controlled termination which turns the first power switch on and off, wherein the first terminal of the first power switch is connected to the first terminal of the input voltage source. A second power switch has first and second terminals and a controlled termination which turns the second power switch on and off, wherein the second terminal of the second power switch is connected to the second terminal of the input voltage source and the first terminal of the second power switch is connected to the second terminal of first power switch. An inductor element is connected between a common connection of the first and second power switches and the output capacitor. A shorting switch module includes a unidirectional switch in series with a controlled switch and further in series with a voltage injection voltage source, wherein the controlled switch has a controlled termination through which the controlled switch is turned on and off, and the shorting switch module is connected in parallel with the inductive element.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 presents a buck topology including some of the parasitic elements;

FIG. 2 presents waveforms associated with the circuit from FIG. 1;

FIG. 3 presents waveforms an embodiment of the buck topology;

FIG. 4 depicts a prior art method to obtain zero voltage switching in a buck topology;

FIG. 5 depicts waveforms of the circuit presented in FIG. 4;

FIG. 6 depicts a prior art method to obtain zero voltage switching in a buck topology;

FIG. 7 depicts waveforms of the circuit presented in FIG. 6;

FIG. 8 presents some the equation of the buck topology with parasitic elements;

FIG. 9 presents a buck topology using a shorting switch with a voltage injection module;

FIG. 10 presents waveforms of the circuit from FIG. 9;

FIG. 11 presents the shorting switch with voltage injection module;

FIG. 12 presents the low loss shorting switch with voltage injection module;

FIG. 13 presents the implementation of the dual shorting switch with voltage injection module;

FIG. 14 presents another implementation the dual shorting switch with voltage injection module;

FIG. 15 presents a buck topology using a dual shorting switch with voltage injection module;

FIG. 16 presents waveforms associated with the circuit depicted in FIG. 15;

FIG. 17 presents a bidirectional buck power cell wherein the power is transferred from left to right;

FIG. 18 presents a bidirectional buck power cell wherein the power is transferred from right to left;

FIG. 19 presents a multiphase buck topology using the dual shorting switch with voltage injection;

FIG. 20 presents a buck topology using a shorting switch with energy extraction and current injection;

FIG. 21 presents waveforms of the circuit from FIG. 20;

FIG. 22 presents an LLC topology using a four-legged magnetic core;

FIG. 23 presents the current flow on one of the layers for the circuit presented in FIG. 22;

FIG. 24 presents the current flow on one of the layers for the circuit presented in FIG. 22;

FIG. 25 presents the current flow on one of the layers for the circuit presented in FIG. 22;

FIG. 26 presents the current flow on one of the layers for the circuit presented in FIG. 22;

FIG. 27 presents the primary winding implementation of the circuit presented in FIG. 22;

FIG. 28 presents a dual interleaved asymmetrical half bridge; and

FIG. 29 presents waveforms of the circuit from FIG. 28.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

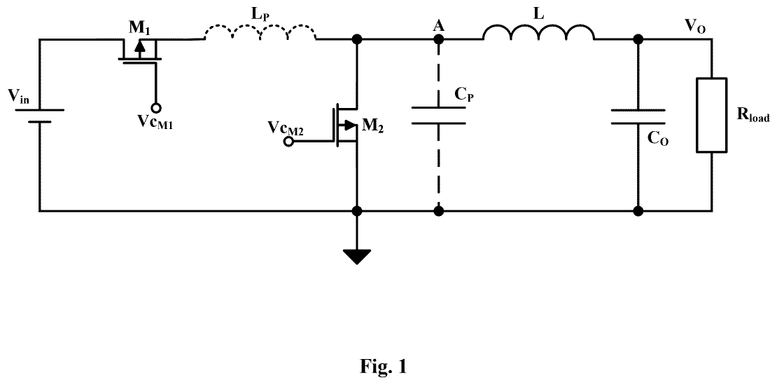

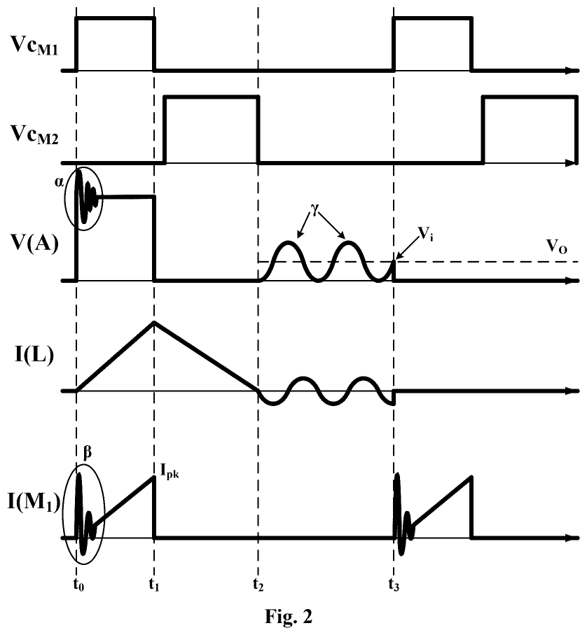

FIG. 2 depicts waveforms associated with the circuit shown in FIG. 1. The waveforms include: the control signal VcM1 of the first switch, M1, the control signal VcM2 of the second switch, the voltage in the switching node A, the current through L and the current through M1. This topology has several drawbacks which are underlined by the marked areas such as “x”, “B”, and “y”.

At to the main switch M1 turns on when the voltage across M1 was at a level Vin, and the turn on is done in a hard switching mode by sharply charging the capacitor Cp, which was charged at zero voltage, and charges to Vin level. The charge of Cp leads to a current spike depicted by the area “B”. The sharp charge of Cp via the parasitic inductance Lp leads to ringing in the switching node A, depicted by the a area. That leads to switching losses in addition to the noise which couples to the rest of the circuit. Between t0 to t1 the current builds up via the inductor element L, imposed by the voltage across L, which is (Vin−Vo).

At t1 the main switch M1 turns off and the current flowing through L further starts flowing via the body diode of M2. Until the second switch M2 turns on the current imposed by L flows via the body diode of M2. The interval between turn off of M1, at t1 and the turn on of M2, it is a dissipative interval due to the voltage drop across the body diode of M2. By design this time interval has to be minimized in order to minimize the power dissipation in the buck cell depicted in FIG. 1.

After M2 is turned on the current imposed by L flows through a lower impedance path which is the Ron of M2. The current through L starts decaying from the Ipk level to zero at t2.

In between t2 to t3, the parasitic oscillation on the switching node A is depicted by “y”. The voltage ringing across Cp is associated with a current ringing through L as depicted by the waveform I(L).

The energy contained in the parasitic oscillations are proportionate with the output voltage Vo. For buck converters which power AI wherein the voltage Vo has a low amplitude this energy is negligeable.

To minimize the switching losses when switch M1 turns on, the turn on of M1 is done on the peak of the parasitic oscillations in the switching node A.

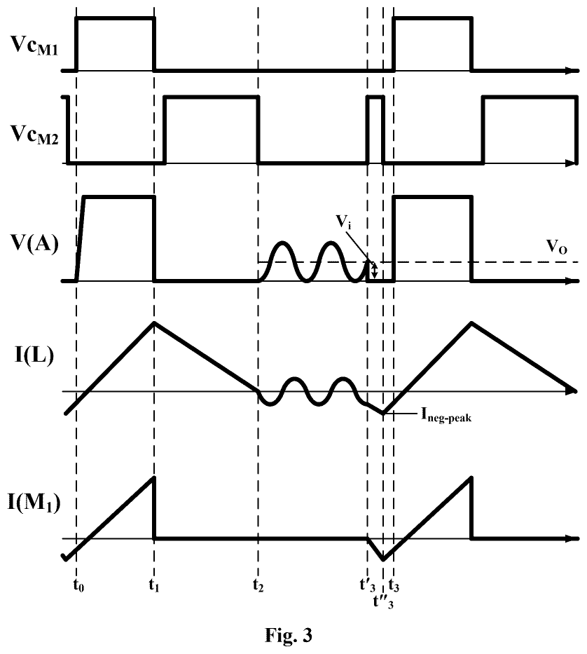

One solution is proposed for application wherein Vin>>Vo. In such applications, the focus is on the first switch M1, because the switching losses are higher on M1 in such applications. FIG. 3 depicts such an implementation. The waveforms depicted in FIG. 3 include: the control signal for M1, VcM1, the control signal for M2, VcM2, the voltage on the switching node A, the current through L, I(L), and the current through M1, I(M1).

The difference between the waveforms from FIG. 2 which are associated with the circuit of FIG. 1 and the waveforms from FIG. 3 is the presence of a the additional pulse on the VcM2, between t3′ and t3″. At t3′ the second switch M2, turns on. The t3′ occurs during the parasitic oscillation time interval (t2 to t3′). The turn on of M2 is done in the hard switch mode when the voltage in A has the amplitude Vi as depicted by V(A) from FIG. 3. When M2 turns on a negative current starts to build up, flowing from Vo, though L and M2. At t3″ the current through L reaches a peak negative amplitude Ing-peak.

At t3″, M2 turns off and the current through L continues to flow, charging the parasitic capacitance Cp until V(A) reaches the level of the Vin creating zero voltage switching conditions across M1. The second switch M2 turns on in the hard switch mode at t3′ when the voltage across Cp is Vi. However, Vi has a low amplitude of less than 2*Vo, and as a result, the switching losses are much smaller in comparison with the switching losses which may occur on M1 in hard switch mode.

The buck topology from FIG. 1 wherein the control for M1 and M2 is done as depicted in FIG. 3 is a suitable solution for application wherein Vin>>Vo, such as 48V bus and Vo=1V. The solution is simple and does not require additional hardware.

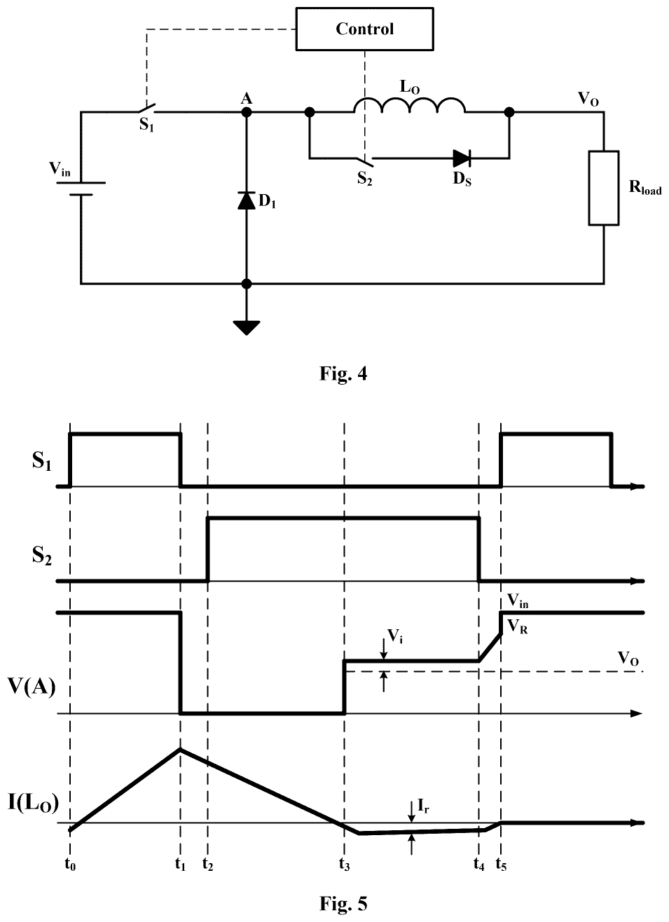

FIG. 4 depicts a buck converter cell which contains an additional unidirectional clamp switch formed by a switch S2 in series with a diode Ds.

FIG. depicts depicted the waveforms associated with this buck converter cell, such as: the control signal for the switch S1, the control signal for the additional switch S2 which is complementary signal to S1, the voltage in the switching node A, and the current through Lo, I(Lo).

Unlike the conventional buck topology presented in FIG. 1, the second switch M2 is replaced by a diode, D1, but this change does not substantially change the mode of operation.

Between t0 to t1, S1 is turned on and the current starts flowing from Vin towards Vo via Lo, current with an increased slope defined by (Vin−Vo)/Lo. The operation during this time period is the same as the buck converter cell from FIG. 1.

At time t2, shortly after the switch S1 turns off, the additional switch S2 is turned on. In between t1 to t3, the current through Lo starts decaying with a slope Vo/Lo.

At t3 the current through Lo reaches zero level.

After t3 the negative magnetizing current, which in conventional buck topology provides the energy for the parasitic oscillation between t2 to t3 as presented in FIG. 2. In the structure depicted in FIG. 4, the negative magnetizing current is trapped via S2 and Ds. As depicted in FIG. 5, the current Ir in between t3 to t4 is approximately constant with a decay in amplitude caused by the conduction losses and the voltage across Ds.

At t4, when the additional switch S2 is opened, the negative magnetizing current Ir starts charging the parasitic capacitance reflected across the switching node A. During the time interval between t3 to t4, the voltage in A is approximately the same level as Vo plus the voltage across Ds, assuming that the voltage across S2 when S2 is conducting it is zero.

In between t4 to t5, the voltage in A increases until the level VR which has approximately the same amplitude as the peak of the parasitic oscillation in A, in applications wherein the unidirectional switch formed by S2 and DS is not implemented.

In applications wherein Vin>>Vo such as Vin=48V and Vo=1V, the VR may reach 2*Vo which is much smaller than Vin level and S1 turns on in hard switch mode leading to current spikes and switching losses.

In order to obtain zero voltage switching especially in conditions wherein Vin>>Vo, additional energy has to be injected in the inductive element Lo. One solution for energy injection is in the inductive element for buck topology.

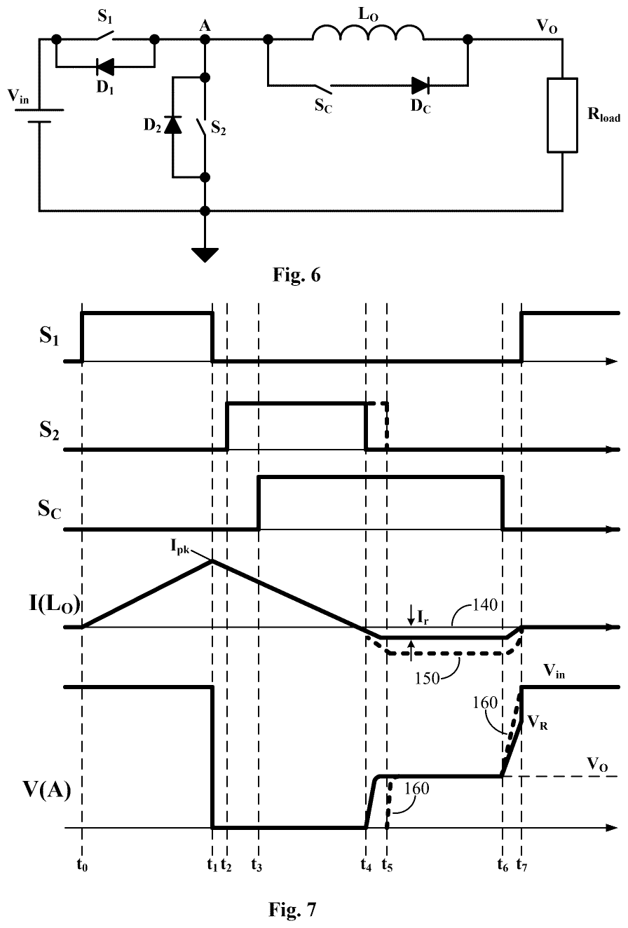

FIG. 6 shows a buck topology in which energy injection in the inductive element Lo is implemented. In the buck converter cell presented in FIG. 6, there are two switching elements S1 and S2 each one having a diode across them which emulates the body diode in case Mosfets is used to implement the switching elements.

In addition to the switching elements, a unidirectional switch formed by SC and DC is placed across the inductive element Lo.

The waveforms associated with the buck converter cell from FIG. 6 are depicted in FIG. 7. The waveforms presented in FIG. 7 include: the timing for the switching element S1 and S2 and SC, the current through Lo and the voltage in the switching node A.

Between t0 to t1, the switch S1 is conducting. During this time interval the current flows from Vin, through S1, Lo towards Vo. The current has a current slope determined by (Vin−Vo)/Lo. At t1 the current through Lo reaches a peak current Ipk.

At t1 the switch S1 turns off and the current through Lo continues to flow initially through D2 and after t2 the current flows via the switch S2.

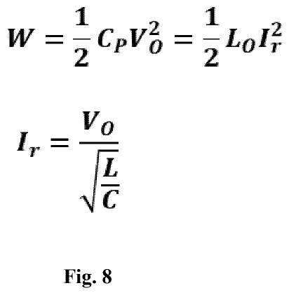

The current flowing through Lo decays with a slope of Vo/Lo towards zero wherein the current through Lo, I(Lo) reaches zero at t4. In the event S2 turns off at t4, the negative magnetizing current is Ir, 140, and its amplitude is given by the formula in FIG. 8. In such a case, at t6 when the Sc turns off, the negative magnetizing current (Ir) is able to change the parasitic capacitance reflected in node A only to VR level as presented in the waveforms V(A).

To inject more energy in Lo the second switch S2 is preferably turned off later at t5 instead at t4. During this time interval, more “reverse” current, 150, can be injected from Vo and the new reverse current charges the parasitic capacitance reflected in the switching node A in such way that the voltage in A reaches the input voltage level, Vin, and the first switch S1 turns on at t7 under zero voltage switching conditions.

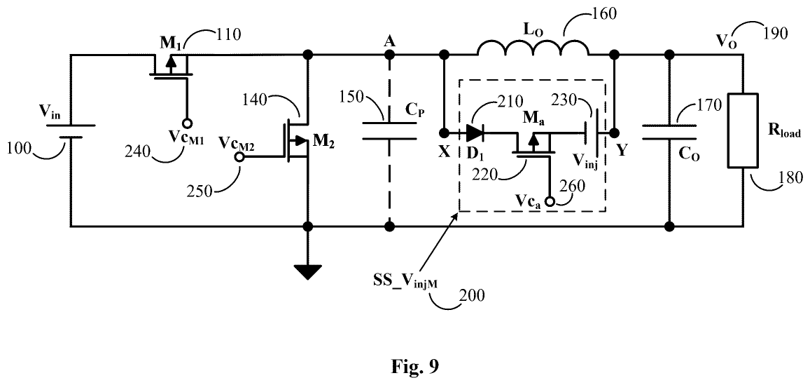

There is another method of injection of energy into a buck and boost topology by placing a voltage source in series with the unidirectional additional switch as depicted in FIG. 9. FIG. 9 presents a buck converter cell wherein in series with the additional unidirectional switch formed by D1,210, and M1,220, there is a voltage source Vinj,230. The unidirectional switch formed by D1, Ma in series with Vinj form a module named “SS_VinjM”,200. This solution is referred to herein as “Rompower 1”.

The role of the additional voltage injection source is to inject energy into the inductor Lo during the time the additional unidirectional switch is on.

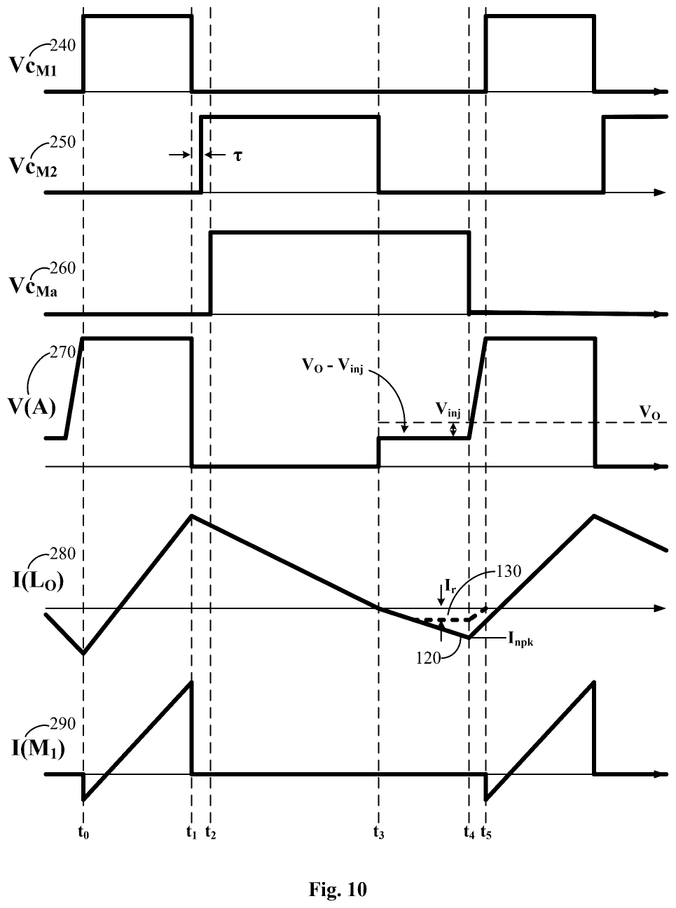

The waveforms associated with the circuit presented in FIG. 9 are depicted in FIG. 10.

In FIG. 10 are presented the control signal for the first switch M1, VcM1, 240, the control signal for the second switch M2, VcM2, 250, the control signal for the additional switch Ma, Vc(Ma), 260, the voltage in the switching node A, V(A), 270, the current through the output inductor Lo, I(Lo), 280, and the current through M1, I(M1),290.

From t0 to t1, the first switch M1, 110, turns on and the current starts flowing from Vin, 100, via Lo, 160, towards the output Vo,190. During this time energy is stored in the inductor element Lo,160, and also a certain amount of energy is transferred to the output.

After a dead time “σ”, 222, the second switch M2, 140, is tuned on. During this dead time the current flowing through Lo flows via the body diode of M2. After M2 turns on the current through Lo flows via M2 which is turned on in between t1 to t2.

At t2 the additional switch Ma, 220, is on. The current flowing through Lo decays at the rate of Vo/L.

At t3 the current through Lo reaches zero and the secondary switch M2 turns off. Without the Vinj, the current Ir, 130, between t3 to t4 has a given amplitude presented in FIG. 8. The Vinj increases the amplitude of the negative current through Lo as depicted by the curve, 120, in the I(Lo) in FIG. 10.

In between t3 to t4 the voltage in the switching node A is (Vo−Vinj).

At t4, Ma turns off, the current through Lo reaches a peak the amplitude Inpk, and that current starts charging the parasitic capacitance Cp, reflected in the switching node A, until reaches the level of Vin at t5 creating zero voltage switching on the first switch M1,110.

The Rompower 1 solution has an advantage for low Vo. In FIG. 7, the time interval between t4 to t5 controls the amplitude of the negative current through Lo to the necessary amplitude to charge the parasitic capacitance Cp to Vin level before t5. The time interval between t4 to t5 it is a “dead time” which limits the maximum duty cycle, said “dead time” it is larger for a lower Vo. That means that for low output voltage such as 1V the maximum duty cycle is reduced.

In the Rompower 1 solution, the “dead time” can be reduced to the desired level by controlling the Vinj level and the maximum duty cycle can be larger than in Vicor solution.

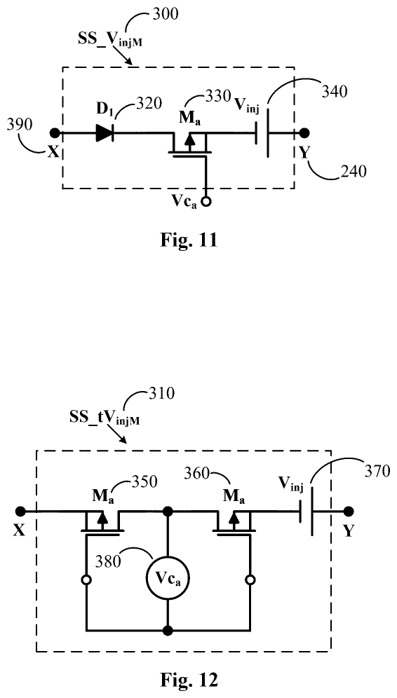

FIG. 11 presents the “Shorting Switch, Vinj Module” which is a module presented in FIG. 9. This module, labeled “SS−VinjM”, 300, is formed by a unidirectional switch formed by a diode, D1, 320, a control switch Ma, 330, controlled by a controlled VCa signal, and a voltage source Vinj,340. The “SS−VinjM”,300, module has two terminations, X,390, and Y,400. Because the negative magnetizing current, between t3 to t4, from FIG. 10, has a small amplitude in comparison with the positive magnetizing current, the voltage drop on Ma is relatively small. However, the voltage drop on D1 decays the amplitude of the negative magnetizing current and for that reason in FIG. 12 there is another implementation of “SS−VinjM” wherein the unidirectional switch formed by D1 and Ma is replaced by two back to back mosfets, Ma1,350, and Ma2,360, and wherein the VCa,380, is activated only when the voltage in X is larger or equal to the voltage in Y. This method eliminates the physical need for the diode D1 and it is replaced by a control method.

The next embodiment of this disclosure is referred to as “Rompower 2”.

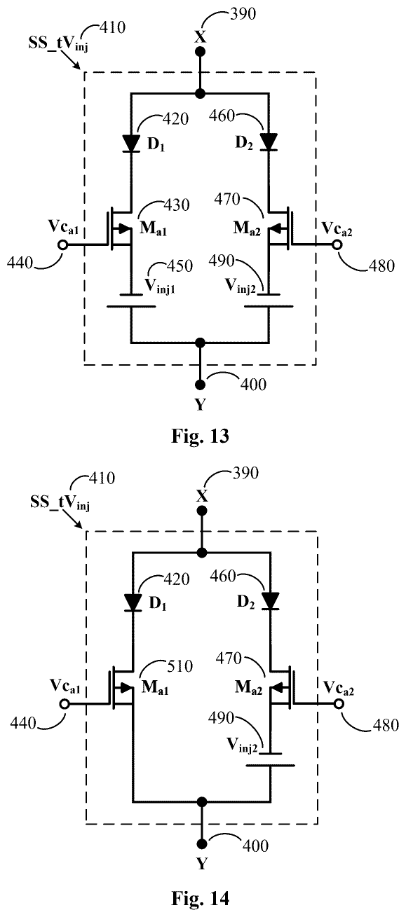

Another solution in injecting energy in Lo by controlling the Vinj amplitude is shown in FIG. 13. The “Shorting Switch, Vinj Module” from FIG. 11 is modified as presented in FIG. 13, named the “Shorting switch, timed Vinj Module”, abbreviated “SS_tVinjM”, 410, is composed by two branches, the first branch formed by a diode D1,420, Ma1,430, in series with a Vinj1,450, and the second branch is formed by a diode D2,460, a switch Ma2,470, and a voltage source Vinj2,490. In most of the application the “Shorting Switch, timed Vinj Module” is abbreviated as “SS_tVinjM”, has Vinj1=0, as depicted in FIG. 14.

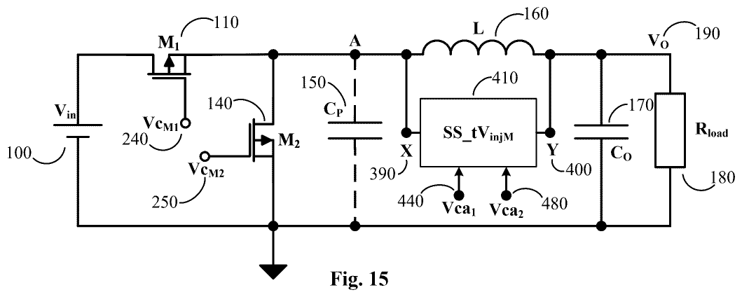

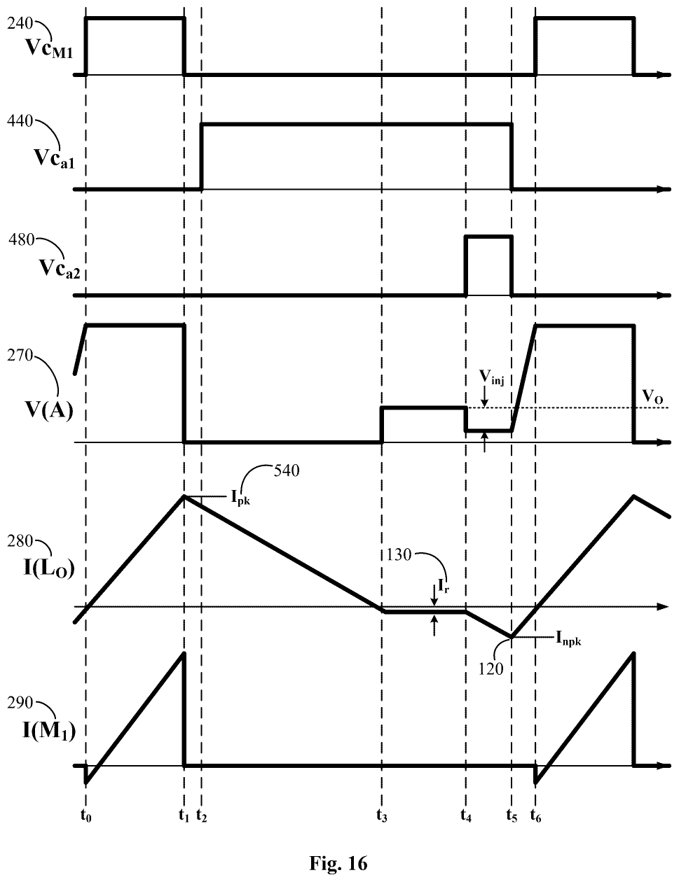

FIG. 15 depicts the buck converter cell wherein the “SS_VinjM” is replaced by “SS−tVinjM”, controlled by two control signals Vca1,440, and Vca2,480. FIG. 16 presents waveforms of the circuit presented in FIG. 15. This solution is named “Rompower 2”.

The waveforms presented in FIG. 16 are: the control signal for the first switch M1, 240, the control signal for the switch Vca1,250, controlling the Ma1 from FIG. 14, the control signal for the switch Vca2, 265, controlling the Ma2 from FIG. 14, and further the voltage in switching node A, V(A),270, the magnetizing current Ir,130, flowing through Lo,160, and the current through the first switch M1,110, I(M1), 290.

In between t0 to t1, the first switch M1 turns on and the current builds up via Lo with a slope proportional to (Vin−Vo)/Lo. At t1 the current though Lo reaches the peak current Ipk, 540.

At t2, the switch Ma1 is turned on. Further, the current through Lo starts decaying with a slope proportionate to Vo/Lo. At t3 the current through M1 and Lo reaches zero and M1 turns off. After t3 the current through Lo turns negative with an amplitude Ir,130. The Ir represents the energy contained in the resonant circuit with initial conditions, the resonant circuit formed by Lo and the parasitic capacitance Cp reflected across the switching node A, wherein Ir is presented in FIG. 8. In between t3 to t4 the negative magnetizing current Ir flows via D1 and Ma1 from FIG. 14.

At t4 the switch Ma2 is turned on and the negative magnetizing current starts flowing via the second branch of the module “SS_tVinjM” via, D2 and Ma2 time wherein Vinj2 increases the negative magnetizing current from Ir level to Inpk, 490, level. In between t4 to t5 energy is injected by Vinj2 in the Lo in order to increase the negative magnetizing current to a level, Inpk, sufficient to charge the parasitic capacitance Cp from (Vo−Vinj) to the Vin level creating zero voltage switching conditions for the first switch M1 at t6.

The “Rompower 2” solution allows full control of the soft switching for the buck converter cell. For a given Vinj2 amplitude, the time interval between t4 to t5 fully controls the Inpk to ensure zero voltage switching of the buck converter in any operating mode. In the “Rompower 1” and “Rompower 2” solutions, the ZVS does not depend on the amplitude of Vo, and the maximum duty cycle can by maximized by increasing the amplitude of Vinj and Vinj2, respectively.

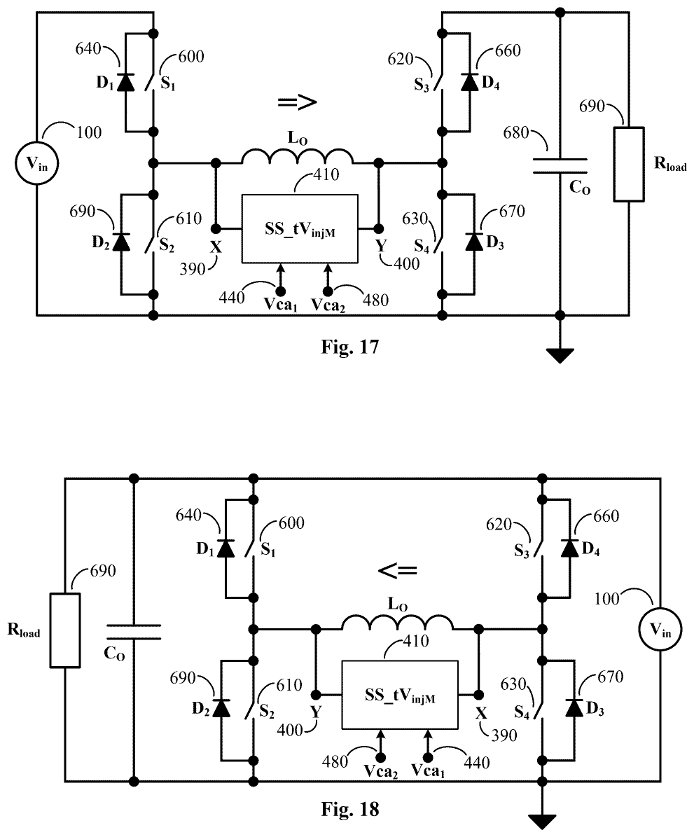

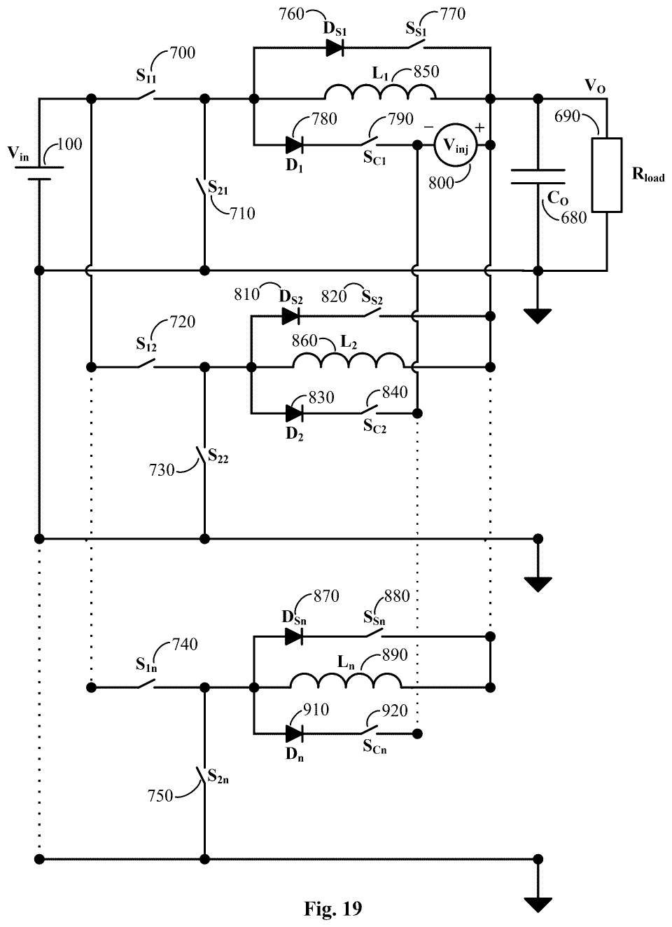

The solution proposed can also apply in buck-boost cell as depicted in FIGS. 17 and 18. The power can be transferred from left to right as depicted in FIG. 17 and from right to left as depicted in FIG. 18.

FIG. 19 depicts a chain of interleaved buck converter cells. Each cell continues with a first switch S11,700, S12,720, and so on until Sin,740. Each cell has also a second switch such as S21,710, S22,730, and so on until S2n,750. Each cell contains a magnetic element such as L1,850, L2,860, and so on until Ln,890. Across each inductive element there is a unidirectional switch such as Ds1,760, and Ss1,770, Ds2,820, and Ss2,820, and so on until Dsn,870, and Ssn,880.

In addition to that across each inductive element, there is a second unidirectional switch such as D1,780, and Sc1790, D2,830, and Sc2,840, until Dn,980, and Scn920, all the second unidirectional switches are connected is connected to one end to Vinj,800, voltage source as depicted in FIG. 19.

The on time for the second unidirectional switch (Sc1 to Scn) controls the Inpk per each cell and ensures zero voltage switching for each first switchers from S11, S12 until S1n.

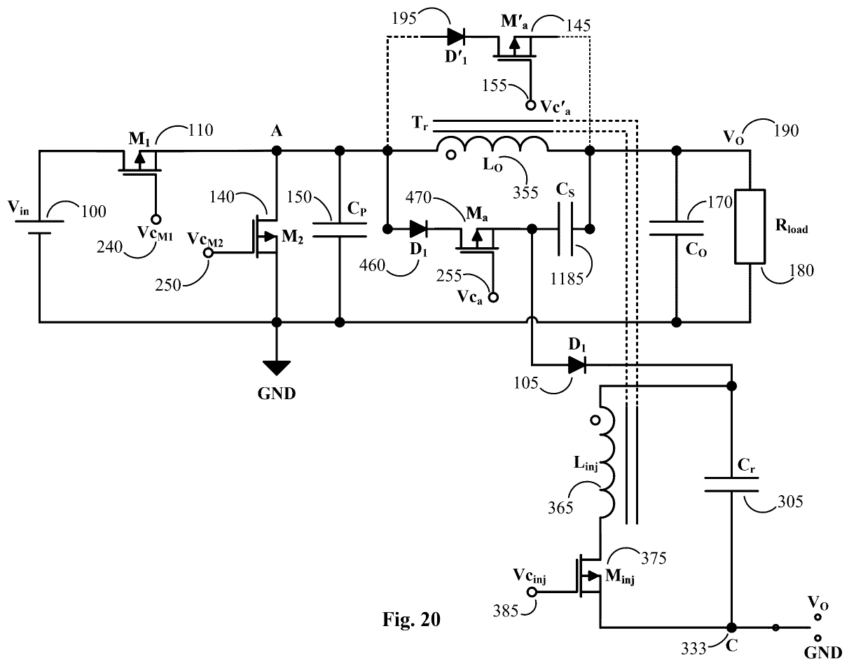

FIG. 20 depicts another solution for soft switching Buck converter cell.

The following embodiment of this disclosure referred to herein as “Rompower 3”.

FIG. 20 depicts the first switch M1,110, and a second switch M2,140, an inductor element Lo,355, and an output formed by a capacitor Co,170, and a Rload,180. In addition, there is a unidirectional switch formed by a diode D1,460, in series with a mosfet Ma, 470, said unidirectional switch is in series with a capacitor Cs,185. This structure is placed across Lo,355. In addition, there is a current injection circuit formed by a winding Linj,365, coupled with Lo, a resonant capacitor Cr,395 and a Minj,375, mosfet connected to the resonant capacitor and this common connection is labeled “C”,333.

The connection “C”,333, can be connected to Vo,190, and in applications wherein Vin>Vo the “C” can be connected to ground. An interconnection diode D1,105 is placed in between the resonant capacitor Cr,395, and the common connection between Ma,470, and Cs,185.

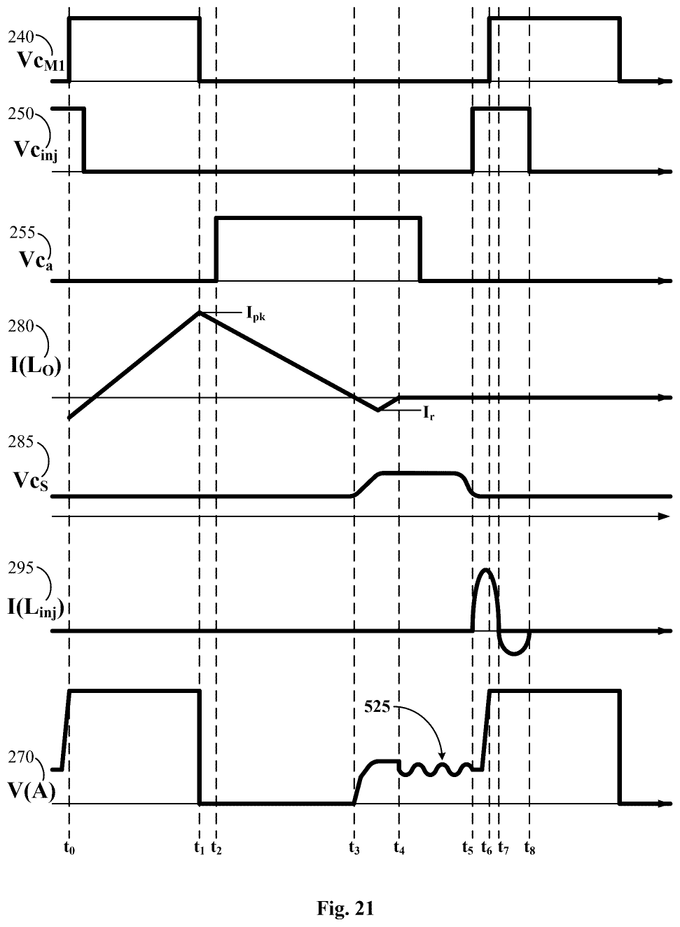

FIG. 21 presents waveforms for the circuit from FIG. 20. The waveforms include: a control signal for M1, VcM1,240, the control signal for Minj, Vcinj, the control signal for Ma,470, Vca,255, the magnetizing current of the magnetic structure formed by Lo,355, and Linj,365, I(Lo), the voltage across Cs, VCs, 285, the current injection flowing through Linj and Minj, and the voltage in the switching node A, V(A),270.

Between t0 to t1 the first switch is on and the current flows through M1 and Lo towards Co and Rload. At t1 the current through Lo reaches its peak, Ipk.

At t1, the first switch M1 turns off and the current continues to flow through Lo with a negative slope of Vo/Lo.

At t3, the current through Lo crosses zero and goes into negative polarity, which represents the energy associated with the parasitic oscillations which would manifest if the clamp circuit formed by D1, and Ma were not placed in the circuit.

The energy contained in the parasitic oscillations presented in FIG. 8 is transferred to the capacitor Cs, during the time interval t3 to t4.

Between t4 to t5 there is a residual parasitic oscillation. The amplitude of the parasitic oscillation has a much lower amplitude by comparison with the parasitic oscillation, and the amplitude of the residual parasitic oscillation can be further reduced when an additional diode D1′ in series with a switch Ma′ are placed across the Lo,355, as depicted with the dotted line in FIG. 20.

At t5, the current injection switch is turned on and a current injection pulse is injected into the Lo via the leakage inductance between Linj and Lo. The energy for the current injection pulse comes from the storage capacitor Cs,185, which harvests the energy from the parasitic oscillations between t3 to t4 and also from the resonant capacitor Cr,395. The current injection pulse is injected from Linj to Lo via the leakage inductance between Linj and Lo, both wound on the transformer Tr1. The current injection pulse charges the parasitic capacitance reflected in the switching node A, to the level of Vin creating zero voltage conditions for M1 at t6. Between t7 to t8 the resonant capacitor Cr is charged from Vin via the leakage inductance between Lo and Linj. The charge of the Cr is done in a quasi-resonant way and at t8 the charge cycle of Cr is ended.

Some of the advantages of the Rompower 3 solution include:
1. The energy from the parasitic oscillation is extracted and stored in the storage capacitor Cs.
2. The current injection circuit formed by Minj, Linj and Cr uses the energy extracted from the parasitic oscillation and charge the parasitic capacitance Cp reflected across the switching node A to Vin level creating zero voltage switching conditions for M1.
3. In applications in which the energy in the parasitic oscillation is not enough to create zero voltage switching conditions for the first switch, the value of the resonant capacitor can be tailored to extract more energy from the input voltage Vin and charging the Cinj capacitor.
4. The magnetic flux in the Lo does not increase.
5. In the Rompower 1 solution, Vinj preferably has a certain amplitude to obtain zero voltage switching conditions for M1. In the Rompower 2 solution, the Vinj2 and the time interval wherein Vinj2 has to be applied are preferably tailored. In Rompower 3, the pulse which turn on Minj need not be modulated by a control mechanism. The energy stored in Cr is proportionate with the Vin level which offers a self-adjusting feature of the current injection circuit. At higher Vin, the current injection amplitude is automatically larger in order to charge Cp to reach Vin level and at lower Vin the amplitude of the current injection is self-adjusting to be lower. This self-adjusting feature eliminated the need for a more complex control mechanism to ensure zero voltage switching conditions for M1.

The fast-increasing demands of digital service, internet traffic, and artificial intelligence are driving significant technological breakthroughs management solutions for data centers and server racks. The move towards a 48V bus reduces losses significantly but requires very efficient and very high-power density converters to be located in proximity of the loads.

The LLC resonant converters have emerged as a preferred topology for an intermediate 48V to 12V or even lower voltages. A magnetic structure is proposed wherein the output current is distributed via a number of synchronous rectifiers, synchronous rectifiers which share the total output current.

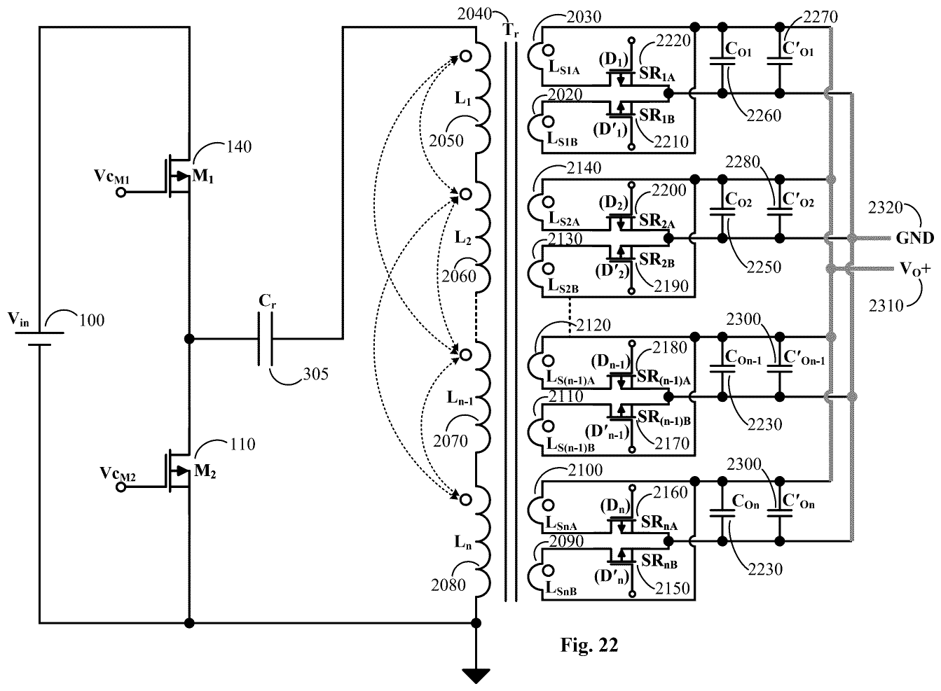

FIG. 22 presents an LLC resonant converter wherein the magnetics is based on a multilegged magnetic technology. In the LLC resonant circuit in FIG. 22, there are two phases, phase A and phase B, determined by the polarity of the primary current. During phase A, M1 is conducting and during phase B, M2 is conducting.

FIG. 22 presents a LLC resonant converter using a number of parallel rectifier means, depicted in this drawing as synchronous rectifiers, D1(SR1A),2220, D2(SR2A),2200 . . . Dn(SRnA),2160, which rectify during the phase A, and D1′(SR1B),2210,D2′(SR2B),2190 . . . Dn′(SRnB),2150 which rectify during the phase B.

There are “n” power cells, each power cell containing four inner magnetic posts. The analysis of the current flow is done here for the first power cell, and the same mechanism applies to the rest of the power cells.

The rectifier means and the capacitors, Co1,2260, Co2,2250 . . . Con and Co1′,2270, Co2′, 2280 . . . Con′,2300 are placed on the top and bottom of the multilayer PCB structure wherein the transformer winding Tr, are embedded. The distribution of the rectifier means, and the capacitor is done for criteria of spreading the power dissipation uniformly over the multilayer structure and spreading the RMS current uniformly through the capacitors Co1,2260, Co2,2250 . . . . Con,2230. and Co1′,2270, Co2′,2280 . . . . Con′,2300. In most of the applications the rectifier means are synchronous rectifiers to reduce the conduction losses in the rectifiers means.

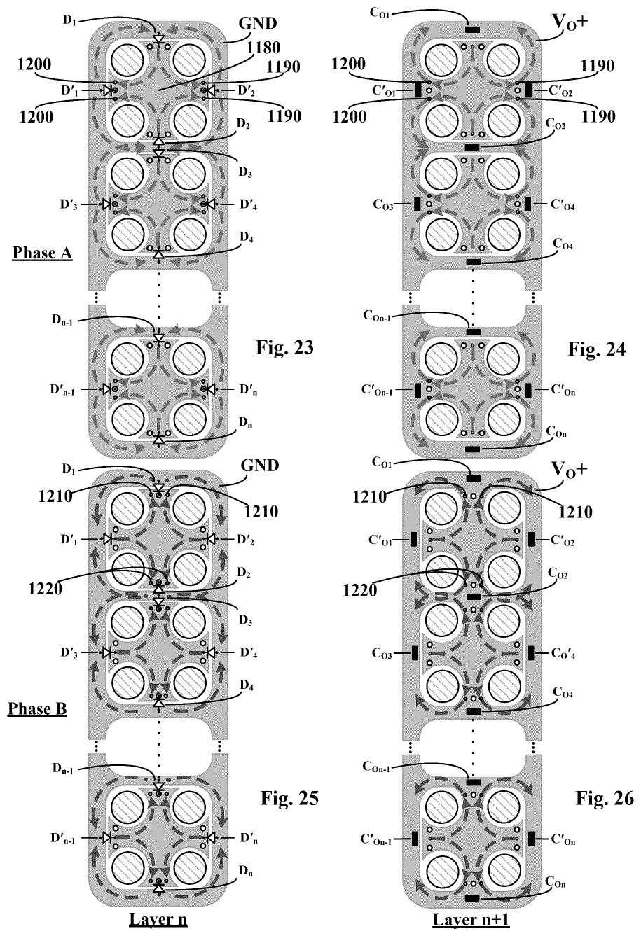

As depicted in FIG. 23 during the phase A, the current in the secondary winding flows from the GND,2320, on the layer n via D1 and through the cross shaped copper plane, 1180, in between the magnetic posts towards the vias 1190 & 1200 and further to the layer n+1, and through the copper plane dedicated to Vo+ (FIG. 22), and to the capacitor Co1 which connects the Vo+ to GND.

During this phase A the current flows also via D2, from the GND plane placed on layer n, further through copper plane, 180, towards the via 1190 and 1200 and further to the layer n+1, to Vo+which surrounds the four magnetic posts and to the capacitor Co2, which connects Vo+ and GND.

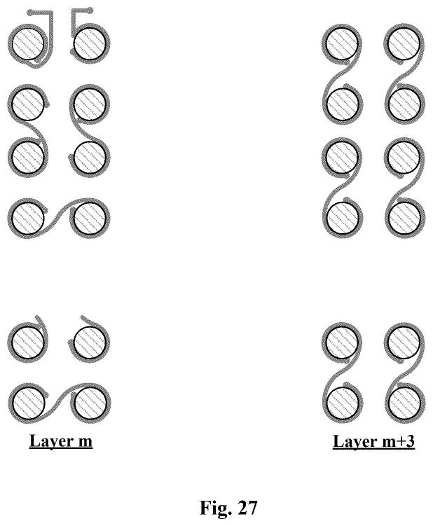

FIGS. 25 and 26 depict the current flow into the secondary windings during phase B.

During phase B, the current flows from GND plane via the D1′ through the plane 1180, on layer n, and further through vias 1210 and 1220 to the Vo+ copper plane around the center posts to the capacitor Co1′, and also from the GND via D2′ via the plane 1180, on layer n and further through vias 1210 and 1200 to the copper plane Vo+ placed around the center posts to the capacitor Co2′.

The rectifier means D1,2220, D2,2200, D1′,2210, and D2′,2190, and the capacitors Co1,2260, Co2,2250, Co1′,2270, and Co2′,2280 are not placed on the layers n and n+1, are placed on top and the bottom of the multilayers PCB. In FIGS. 23 and 24, the diodes and the capacitors are symbolically placed just to follow the current flow.

In center tap topology, current flows through only one winding on each phase. Copper may not be well utilized in such an arrangement.

In current doubler topology, the current in the secondary winding flows in both directions, one direction during phase A and one direction during phase B. There is no secondary winding not conducted during one of the phases. However, the penalty of the current doubler is the need for two output inductors.

In Rompower winding implementation of layer n and layer n+1, the current flows in both directions through the copper traces which form the secondary winding. During phase A as depicted in FIGS. 23 and 24, the current flows in one direction through the copper plane 1180, the GND and Vo+ copper plane.

During phase B the secondary current flows in opposite direction through the copper plane 1180, and through GND,2320. and Vo+,2310, copper plane as depicted in FIGS. 25 and 26. This feature leads to a much better utilization of copper. Only through the vias 1190, 1200, 1210 and 1220 the current flows in only one direction during phase A and phase B.

The presence of the ground plane for 1180, GND and Vo+ and not traces, allows the current to flow freely in an optimized path to minimize the impedance and ensure that the magnetic field produced by the primary winding is cancelled. This leads to a much lower leakage inductance in the secondary winding and a linearization of the magnetic field forced to be parallel with the conductive copper plane, minimizing the Rac impedance and reducing the losses.

In addition, the Vo+ and GND are placed on top of each other creating an additional parasitic capacitance which is in parallel with the discreate capacitors, Co1,2260, Co2,2250, Co1′,2270, and Co2′,2280.

The secondary winding implementation also eliminates the “end effect,” which represents the connection between winding and rectifier means, because the rectifier means are part of the windings.

FIG. 27 depicts the primary windings on the layers m and m+3 assuming that the secondary windings are sandwiched in between the primary windings.

In such an implementations four layers are dedicated to primary and secondary windings forming a set. Additional sets of primary and secondary windings can be further implemented in the multilayer structure.

A suitable topology for zero voltage switching in the primary and zero current switching in the secondary capable of operating with large input& output voltage range is the single ended, flyback derived asymmetrical half bridge. Hybrid flyback topology is a PWM topology in which the primary switchers in the half bridge turn on at zero voltage switching, while the current flowing in the secondary windings is shaped in sinusoidal shape achieving in this way zero current at turn off through the secondary rectifier means. The currents in the secondary windings and in the secondary rectifier means are very similar to the secondary current in resonant converters.

In this topology, there are two distinctive cycles, the first cycle wherein energy is extracted from the input voltage source and store in the magnetizing current of the transformer and also in the resonant capacitor which is in series with the primary of the transformer and the second cycle wherein the energy stored in resonant capacitor and the magnetizing current is transferred to the secondary via a resonant current, sinusoidal shaped.

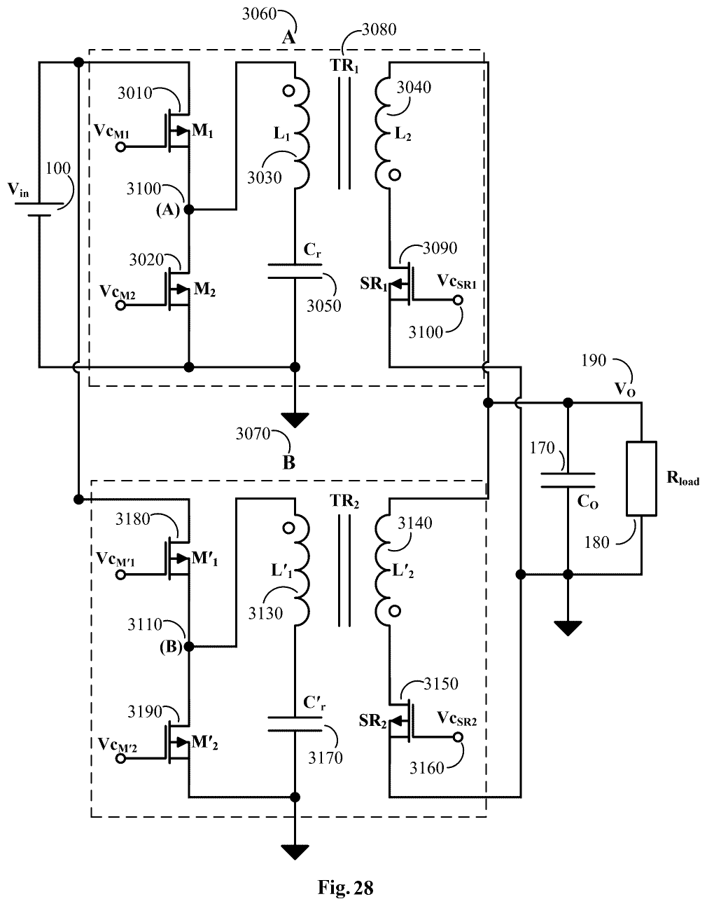

FIG. 28 presents a topology in which two single ended flyback derived asymmetrical half bridge cells are interleaved. The first power cell, A, a half bridge structure formed by an upper switch M1, and a lower switch M2, a transformer Tr1, with primary winding L1 and a secondary winding L2, wherein the primary winding L1 is placed in series with a resonant capacitor Cr. In the secondary there is a winding L2 in series with a synchronous rectifier SR1. The first power cell does have a switch node A.

The second power cell, B, also has a half bridge structure formed by an upper switch M1′, and a lower switch M2′, a transformer Tr2, with primary winding L1′ and a secondary winding L2′, wherein the primary winding L1′ is placed in series with a resonant capacitor Cr′. In the secondary there is a winding L2′ in series with a synchronous rectifier SR2. The second power cell does have a switch node B.

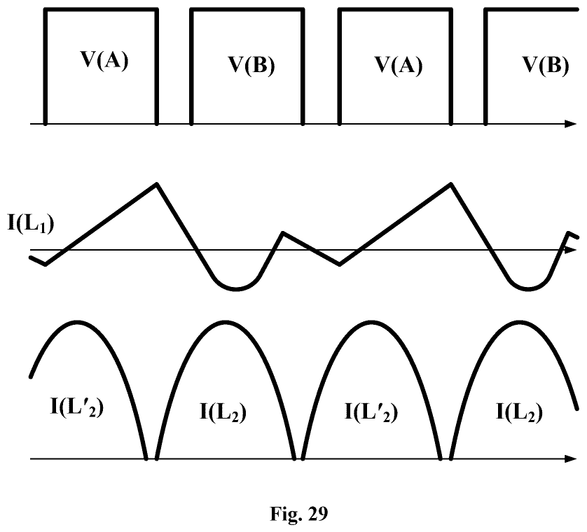

FIG. 29 presents the following waveforms: the voltage in switch node A, the voltage in switch node B, the current through the primary winding of the first power cell I (L1) and the current through the secondary winding L2 and L2′.

The current injected in Co and Rload for this interleaved configuration is the same as of an LLC resonant converter.

This topology, having two interleaved single ended flyback derived asymmetrical Half Bridge cells, has the following features: (a) the secondary current is sinusoidal with low dI/dt; (b) the primary current is triangular, and its amplitude is PWM controlled; (c) it combines a PWM topology with the advantages of resonant output current with zero current switching and zero voltage switching on the primary switchers; and (d) the multileg magnetic structure is very suitable with this topology because of the distributed air gap in posts.

There are some potential applications of this topology for automotive, for larger input and output voltage range such as auxiliary battery chargers wherein the output current can be distributed by the use of the “multileg’” magnetic structure and wherein the input voltage varies more than 2:1. Another application of his topology and the multileg magnetics is industrial power applications. This topology combines the advantages of the PWM topology with the advantages of the resonant topology eliminating in the process the drawbacks of both topologies.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A buck converter comprising:
an input voltage source having first and second terminals;
an inductive element;
an output capacitor connected in parallel to a load resistor;
a first power switch having first and second terminals and a controlled termination which turns the first power switch on and off, wherein the first terminal of the first power switch is connected to the first terminal of the input voltage source;
a second power switch having first and second terminals and a controlled termination which turns the second power switch on and off, wherein the second terminal of the second power switch is connected to the second terminal of the input voltage source and the first terminal of the second power switch is connected to the second terminal of first power switch;
an inductor element connected between a common connection of the first and second power switches and the output capacitor; and
a shorting switch module comprising a unidirectional switch in series with a controlled switch and further in series with a voltage injection voltage source, wherein the controlled switch has a controlled termination through which the controlled switch is turned on and off, and the shorting switch module is connected in parallel with the inductive element.
